(19) United States
(12) Patent Application Publication
(10) Pub. No.: US 2025/0005120 A1
(43) Pub. Date: Jan. 2, 2025

(54) SYSTEM AND METHOD FOR CONTROLLING ACCESS TO TARGET APPLICATION

(71) Applicant: ADUCID S.R.O., Brno (CZ)

(72) Inventor: Libor NEUMANN, Praha 5 (CZ)

(21) Appl. No.: 18/291,735

(22) PCT Filed: Aug. 3, 2022
(86) PCT No.: PCT/CZ2022/050071

§ 371 Date: Jan. 24, 2024

(30) Foreign Application Priority Data
Aug. 4, 2021 (CZ) PV 2021-366

(51) Int. Cl. G06F 21/31

(52) U.S. Cl. CPC G06F 21/31

(57) ABSTRACT

A system and method are described for controlling access of a user to service providers and/or to target applications, in particular web or mobile applications. The system contains a client part and a server part. The client part contains an authenticator, an embedded browser and a data channel module. The authenticator is configured to authenticate the user. The authenticator is also configured to communicate with the user via a graphical user interface of the embedded browser using graphical and control primitives of the authenticator and/or using a stand-alone graphical user interface of the authenticator. The data channel module is configured to communicate with service provider servers via http/https protocol to communicate with the embedded browser and to communicate with the authenticator. The client part further contains a program memory, a variables memory and a control module configured to control the execution of programs stored in the program memory.

### FIELD OF ART

The present invention relates to a (software) system and a (computer-implemented) method for controlling access of a user to a target application and/or to a service provider.

### BACKGROUND ART

Users currently commonly use different web browsers from different producers (Internet Explorer, Edge, Safari, Chrome, Opera, Firefox and others) for working with web applications. These browsers offer a number of standard functionalities to the users.

There are various improvements to the user experience when working with web applications. These are specialized built-in functionalities of browsers from different producers. They include, for example, options for setting and personalizing the graphical interface, such as setting favourite URL addresses, options for remembering and filling in passwords, etc.

There are other extensions to the functionality of browsers (plug-ins) that the user can install in their browser and thereby further expand the functionality of their browser. These options change over time, especially due to newly identified security risks. Consequently it may happen that after updating the browser, some extensions are no longer supported or are disabled.

A common feature of the browsers used today is that they are controlled and set by the users themselves. This requires some expertise on the side of the user and complicates the user experience. The expertise required from the user includes, for example, understanding of the work with server certificates, ability to distinguish a real certificate from a faked one. Therefore, organizational and technological measures are used to assist the users. Such measures include, for example, so-called “green certificates”, i.e. a set of procedures and technical measures to ensure that genuine certificates are marked green by the browser, thereby giving the user a clear signal that the connection is secure. The user is expected to notice such a signal and to respond appropriately. At the same time, however, there are methods of attackers who can forge a fake certificate and at the same time ensure that the browser marks it in green. This represents a non-negligible security risk for the user, as a typical user does not have sufficient level of experience and knowledge in the field of cyber security.

Today, an average user uses dozens to hundreds of websites, and services of dozens of providers. Authentication to these pages is normally based on the username/password technique. This requires the user to manage a large number of passwords. Security recommendations generally prefer complex passwords, and the passwords should be changed frequently. For obvious security reasons, it is not advisable to use the same passwords for multiple accounts or old previously used passwords. But this places almost impossible demands on the user. That is why there are specialized applications or services facilitating this task, the so-called “password managers”. However, even these applications are managed only by the user himself. The choice of a suitable solution and its correct use always depends only on the user, who does not have sufficient knowledge and experience in the field of cyber security. This is a user-unfriendly complication and at the same time an uncontrollable security risk.

The patent application CZ PV 2020-271 is concerned with the problem of improving authentication security and authentication user comfort for web applications by providing a software system including a built-in browser, authenticator and data channel module. However, this system still does not fully address the above-described security risks.

### DISCLOSURE OF THE INVENTION

The present invention relates to a system for controlling access of a user to service providers and/or to target applications, in particular web applications. The system contains a client part (client side) and a server part (server side).

The client part contains an authenticator, an embedded browser and a data channel module, wherein the authenticator is configured to authenticate the user, and optionally to authenticate the data channel. The authenticator is also configured to bind the user authentication to the authenticated channel. The authenticator is further configured to communicate with the user via a graphical user interface (GUI) of the embedded browser using graphical and control primitives of the authenticator and/or using a stand-alone graphical user interface (GUI) of the authenticator. The data channel module is configured to communicate with service provider servers via http/https protocol, to communicate with the embedded browser and to communicate with the authenticator. The client part further contains programs memory (memory configured for storing programs), variables memory (memory configured for storing variables) and a control module configured to control the execution of programs stored in the programs memory. The server part contains at least one authentication server of a browser control manager (browser control manager authentication server).

The client part of the system usually communicates with a server of a service provider in order to provide services or to access data, wherein the provision of services or the access to data require user authentication and/or device authentication. In this text, the term “user authentication” includes user authentication as well as device authentication.

In order to obtain and update programs and trigger rules for their launch and execution, the client part of the system further communicates with the authentication server of the browser control manager. Preferably, this communication is performed on the client side via the authenticator.

The client part of the system containing the programs memory, the variables memory and the control module adapted to control the execution of the programs stored in the programs memory can be installed on one or more user devices and forms one software unit on each user device. On mobile devices, such a software unit is typically called a mobile application. On a computer, such a software unit is typically called an application or a program.

The control module is preferably configured to monitor all communication of the embedded browser with the servers of the service providers. The control module launches (starts) the appropriate program from the programs memory according to pre-defined rules (trigger rules) and controls its execution. Typically, a trigger rule can be a URL fetched from a service provider's website and/or a command entered in the user's embedded browser.

When a pre-defined trigger rule is met (fulfilled), the control module passes the code of the appropriate program for execution, preferably the control module passes the code of the appropriate program to the embedded browser for execution. Trigger rules may be pre-defined for launching the program, as well as for influencing the execution of the program.

The programs stored in the programs memory and executed based on the trigger rules are computer programs created/configured for a specific use, such as for a specific server or web interface or website of a service provider. The program is typically designed to verify the certificate of a website by comparing it with a certificate or the information derived from the certificate that the program contains; and/or the program is typically intended for authenticating communication with a service provider's website; and/or the program is typically intended to facilitate user interaction.

The programs and the trigger rules for their launch and execution are installed into the programs memory and into the control module, respectively, from one or more authentication servers of the browser control manager(s). The system installs the programs and the trigger rules from those browser control manager authentication server(s) which the client part of the system evaluates as trusted. The client part of the system can, for example, have a list of trusted servers, or mutual authentication can be used to verify the browser control manager authentication server. The term “mutual authentication” describes a process in which the client part (client device) authenticates to the authentication server and the authentication server authenticates to the client part, as described for example in CZ 306790 or EP 2208335.

In some embodiments, one or more service providers may simultaneously perform the function of the browser control manager. This means that the authentication server of the service provider also performs the function of the authentication server of the browser control manager.

The program in any form, e.g. source code or translated executable code (preferably, JavaScript is used), is transmitted to the programs memory from the authentication server of the browser control manager in the form of data. The system ensures that appropriate programs are transmitted to authorized users' devices. The appropriate programs are those programs that the user is authorized to use and that are useful for the user. The authentication server may require user authentication before transmitting programs. Due to the authentication, the system ensures that only authenticated users with the appropriate permissions/authorisations have the appropriate programs available on their devices (in accordance with their permissions/authorisations).

Preferably, the browser control manager authentication server(s) in cooperation with the authenticator control the program transmission and management rules. This is mainly due to the authentication server(s) and/or the authenticator determining which authentication servers are trusted and thus allowed to transmit programs to the programs memory, and the authentication server(s) and/or the authenticator optionally also determining what type of programs a given trusted authentication server can transmit to the programs memory. For example, secure communication technologies between multiple entities can be used herein, especially with the use of authentication objects, as described, for example, in EP 3320666.

Programs can use variables from variables memory. If the program needs the value of a variable, it finds it in the variables memory. A program can write the value of a variable or read the value of a variable.

Values of the variables can preferably be encrypted so that the value of the variable can only be read if the user is successfully authenticated.

In one preferred embodiment, the encryption key for decrypting the value of the variable is not stored on the same device as the variables memory, but is stored on an authentication server to which the user or device must authenticate. In another preferred embodiment, the encryption key for decrypting the value of the variable is stored on the same device as the variables memory, the encryption key being encrypted using a public key belonging to a private key stored on an authentication server to which the user or device must authenticate. Only after a successful authentication of the user or device is the encryption key transmitted by the authentication server to the operating memory of the device used by the user and used there to decrypt the value of the variable, or the encrypted encryption key is transmitted via an authenticated secure channel to the authentication server, there it is decrypted using the private key and transferred again through an authenticated secure channel to the operating memory of the device being used by the user, where it is then used to decrypt the value of the variable. This authentication server can be selected from the browser control manager authentication server or the service provider's authentication server.

A variable can contain, for example, confidential data required for the user or device authentication to a service provider, confidential user data or identity provider data, graphic symbols, values necessary for program execution such as a copy the certificate to be controlled, URL of a trusted provider, user identifier, user personal data.

If the user uses a plurality of devices, then the user can have the client part of the system on each of the devices, while all the client parts on the devices of one user can preferably be synchronizable. The term “synchronizable” refers to the possibility to synchronize the programs memory, the trigger rules in the control module and the variables memory between the devices, so that they have the same content in each device.

The embedded browser is a web browser based on international HTML and http/https standards. Such browser can be implemented as part of another program on a computer or mobile device, in any common operating system.

The authenticator is a dedicated program, module, or system designed to securely verify a user identity in cyberspace. For this purpose, the authenticator uses an authentication protocol using cryptographic algorithms, cryptographic keys and/or shared secrets such as passwords, PINs, private and public keys of asymmetric cryptography, certificates, etc. The authenticator preferably authenticates users to all target systems in a uniform manner and does not burden the user with different authentication behaviours for different service providers.

The authenticator communicates with the authentication server of the browser control manager for the purposes of authentication communication, and preferably also for the purposes of transmitting programs and trigger rules, transmitting data from the synchronization queue, and/or decrypting encrypted variables using data stored only on the authentication server.

The authenticator also authenticates a secure data channel between the data channel module and the target web application of a service provider (preferably a TLS channel is used) and participates in binding the user authentication to the data channel authentication. Creating the authenticated channel and binding it to the user authentication secures the communication of the embedded browser with the target application of the service provider. The authentication then does not need to be addressed at the application level of the target web application. The security of using the target web application is thus increased to a level at least comparable to the security of a single-purpose mobile application.

The terms “bind to” and “bind with” are used interchangeably throughout the disclosure.

The user preferably communicates with the target web applications (e.g. service provider applications) and with the authenticator using a standard GUI of the embedded browser (using HTML standard).

The module of graphic and control primitives of the authenticator is used for the communication of the user with the authenticator using the GUI of the embedded browser. The graphic and control primitives of the authenticator are basic elements from which GUI parts are formed, in particular buttons, icons, texts, etc., and which are used to control the authenticator and through which the required actions are transmitted to the authenticator.

This enables a single and repeatable user experience when authenticating. In this preferred embodiment, the management (setup, preference settings, properties settings) of the authenticator can be started, for example, via a dedicated graphic element (e.g. icon) of the authenticator, subsequently the browser activates the corresponding URL containing, for example, the URI scheme registered for the authenticator. The URL contains the corresponding parameters of the authenticator graphical and/or control components. The URL is sent to the local interface of the authenticator graphical and control primitives module, which performs the corresponding actions and returns the necessary data that the embedded browser GUI displays.

In another embodiment, the user communicates with the target web applications (e.g. applications of service provider) via the GUI of the embedded browser. The user communicates with the authenticator via a stand-alone GUI of the authenticator, or partially via a stand-alone GUI of the authenticator and partially via the GUI of the embedded browser using the module of the graphical and control primitives of the authenticator.

The data channel module is a module designed to create a data channel between the client part on the user side and the server part on the service provider side. After the creation of the data channel, the data channel module forms the ending of this channel on the user side. The data channel module is connected (data-linked, connected so as to allow transfer of data, connected as to communicate) to the embedded browser, and is also connected (data-linked, connected so as to allow transfer of data, connected as to communicate) to the authenticator. The data channel module is adapted for communication via http/https protocol and for using cryptographic protocols to secure network communication, such as the TLS protocol.

The service provider is a server or an application that provides services or data to be used by users, wherein the access to that data or services requires user authentication. Individual service providers are usually independent of each other and have their own web or mobile applications. The service provider application can be a target web application that the user accesses using the computer-implemented (program) system of the invention.

The service provider may have their own authentication server or may use an authentication server of an identity provider, for example in federated identity electronic systems. In the present invention, the authentication server of the service provider or the authentication server of the identity provider communicates with the authenticator. In this text, when referring to the authentication server of the service provider, the authentication server of the identity provider is also included in this term.

For example, the service provider may place the ending (on their side) of the data channel established between the service provider and the data channel module according to the invention directly in their web application or on a front-end server (for example on a reverse proxy server) or at another ending of the data channel with https communication.

The authentication server of the service provider can be a server owned or controlled or operated by the service provider, or a server owned or controlled or operated by a third party. For example, in federated identity electronic systems, the authentication server or the authentication service is provided by an identity provider, or through an identity broker. There may be a plurality of identity providers and/or identity brokers in the system.

“Synchronization” is a process performed by the user device and authentication server(s) used to transfer information between multiple devices of the same user. The goal of synchronization is to ensure that the information is identical on all the user devices. The security risks of synchronization are reduced when it uses a secret shared by the user devices to encrypt the data. The secret is only transmitted directly between these devices, but not through authentication servers. Alternatively, the secret shared by the user devices may be passed between the user devices via a server in such a way that the secret is encrypted and the key is available (i.e, stored or provided) only to the user device, but not to the server. Authentication servers are typically used in synchronization.

For example, the following tools can be used for synchronization:

### Synchronization Tool 1—Authentication Server Synchronization Queue:

Synchronization messages containing synchronization data from one user device, timestamped by that user device, are received by the server. The authentication server finds all device replicas, i.e. all devices of the same user (or all devices assigned to the same user account). Received synchronization messages are timestamped by the server with the time of receipt according to server time, and the server copies the synchronization messages to queues on the server for all devices of the same user (except the device from which the server received the synchronization messages). When a user device belonging to a particular synchronization queue connects and authenticates, all relevant synchronization messages are transmitted to this device, and when this device acknowledges their receipt, the transmitted messages are deleted from the queue for this device. Device timestamps are used to group the subsets of the data set and to distinguish and possibly eliminate duplicate synchronization through different authentication servers.

Synchronization Tool 2—Transmitting Synchronization Message from the User Device:

Based on the list of authentication servers on which the user device is assigned to the user account or to the user, the user device activates a secure communication channel with a server from the list, and through this communication channel, synchronization messages are transmitted to the server, where they are received and processed by the synchronization queue of the authentication server.

The invention further relates to a computer-implemented method of controlling the access of a user to a service provider and/or to a target web application, said method using the computer-implemented system according to the invention. The method comprises the steps of:
a) transmitting from the authentication server of the browser control manager to the user device at least one program and the trigger rules for its/their launch, whereby the program(s) is/are stored in the programs memory and the trigger rule(s) is/are stored in the control module in the client part;
b) receiving a user request to use a service of a service provider and/or to access a service provider data and/or to access a target application of a service provider, wherein the request is received via the embedded browser GUI;
c) launching a program according to the trigger rule(s) which is/are fulfilled by the user request, said launching step is performed by the control module;
d) transmitting the user request to a data channel module, wherein the request can optionally be modified by the result of the executed program, and wherein the request is unauthenticated and unencrypted;
e) creating (in some embodiments unauthenticated) data channel with http/https communication between the data channel module and the service provider (wherein this step of creating the data channel may optionally occur also simultaneously with or prior to any of the steps b) to d)), initiating authentication by the data channel module, and transmitting authentication data from the data channel module to an authenticator;
   wherein the launched program may provide data for authentication in the target application and/or to the service provider authentication server, this data preferably being read by the program as values of variables in the variables memory;
   wherein if the program specifies the need for user authentication to read the value of the variable, this authentication is performed by the authenticator and the authentication server of the browser control manager or the authentication server of the service provider before passing the value of the variable to the launched program; and/or
   if it is required to verify the certificate of the service provider or other communication partner (e.g. identity provider), the program compares the certificate received from the service provider or other communication partner with a copy of the certificate contained in the program or stored in the variable corresponding to the program;
f) optionally authenticating the data channel created in step e) and optionally authenticating the user through the authentication communication of the authenticator with the authentication server of the service provider, wherein the data channel is bound to the user authentication;
g) transmitting the user request (optionally modified, and preferably encrypted user request) via the data channel module and the authenticated data channel to the service provider; optionally also transmitting the results of the launched program(s) such as the filled-in items such as username and password;
h) providing the service of the service provider and/or access to the data of the service provider and/or access to the target application of the service provider to the user based on the user authentication and via the authenticated data channel created in step e) and optionally authenticated in step f).

Step a) is typically performed through an authenticator that mediates communication with the browser control manager authentication server over a secure data channel. This step may require authentication of the user or their device or the client part of the system to the browser control manager authentication server.

The term ‘unauthenticated data channel’ used, for example, in step e) means a data channel for which authentication is not fully completed. Thus, it includes a data channel for which authentication has not been initiated as well as a data channel for which authentication has been initiated but not yet completed; for example, authentication has been partially carried out.

Binding the data channel with the user authentication can be carried out by the authenticator and/or the authentication server of the service provider.

Data channel bindings and their use to secure the channels are described e.g. in RFC5929 (ISSN: 2070-1721 July 2010), RFC5056 (November 2007). Binding the data channel with the user authentication may be generally defined as a computer-implemented verification of the fact that a user who has successfully completed authentication uses the appropriate authenticated data channel.

A preferred embodiment of binding the data channel with the user authentication is a procedure of creating the data channel and its subsequent authentication, in which the certificate of the service provider or the target web application is transmitted to the data channel module when creating the data channel. The method of creating the data channel guarantees (e.g. according to the TLS standard) a secure link between the certificate of the service provider or the target web application and the ending of the data channel on the service provider side. The data channel module passes the certificate or information derived therefrom to the authenticator. At the same time, on the service provider side, the certificate is included in the configuration files of the authentication server. The certificate or information derived therefrom is then verified as part of the authentication communication. This, in addition to binding the data channel with the user authentication, also ensures that the authenticator automatically and always flawlessly checks the system certificate of the target web application, which the user himself had to do in prior art solutions.

Other methods of binding a data channel with the user authentication are known in the art (e.g., described in CZ PV 2020-271). For example, such methods may include transmitting data identifying the data channel from the data channel module to the authenticator. This data is then transmitted or processed within the authentication.

Binding the data channel with the user authentication can be carried out in some embodiments by assigning a unique identifier to the data channel created between the data channel module and the service provider before the authentication, and using this identifier as the transmitted data. For example, the data channel identifier may be assigned by the service provider or by the data channel module. The data channel identifier can be, for example, a data channel session identifier or an authentication identifier. To increase security and avoid the risk of an attack on this channel, an additional unauthenticated data channel secret (or a cryptographic material derived from the data channel cryptographic material, e.g. from an unauthorized shared secret of both data channel endings, the creation of which is described, for example, in CZ PV 2013-373) can preferably be used together with the data channel identifier.

Preferably, authentication vectors described in CZ PV 2015-473 can be used for authentication communication involving binding a data channel to user authentication.

### BRIEF DESCRIPTION OF DRAWINGS

FIG. 1 schematically illustrates an example of an embodiment of the system according to the invention.

The following reference numerals are used in the drawing:
1—embedded browser
2—authenticator graphical and control primitives (graphical and control primitives of the authenticator)
3—authenticator
31—authentication communication
4—data channel module
41—data channel with https communication
5—programs memory
6—variables memory
7—control module
8—user
60—service provider
61—target web application of the service provider
62—proxy server of the service provider
63—authentication server managed by the service provider
70—browser control manager
73—authentication server of the browser control manager
74—synchronization queue of the authentication server of the browser control manager

### DETAILED DESCRIPTION AND EXAMPLES OF CARRYING OUT THE INVENTION

In this section, examples of embodiments and uses of the present invention are described. However, this disclosure should not be construed as limiting the scope of the invention which is determined by the claims.

### Application of the Invention in Data Channel Protection:

The aim of such use is to exclude the possibility of the presence of an attacker in the data channel of a target application (Man In The Middle—MITM attack), especially in situations where there is no proxy server on the service provider side providing such protection.

The program is configured to compare the certificate of the used TLS channel with a reference certificate, related to the respective web server (specified by the creator of the program). If the TLS channel has multiple certificates or the certificate changes, the program contains all versions of the reference certificates.

The corresponding trigger rule ensures that the program is triggered whenever the user interacts with the relevant web server, at the time the user accesses the relevant web server using the embedded browser. The program compares the server certificate of the current TLS channel used by the browser with the reference certificate. If there is a match, the program allows the user to access the web server because it is explicitly verified that the data channel is properly secured and not attacked by an attacker. If there is a mismatch, the program displays an error message, using the browser, and prevents the use of the attacked data channel.

### Use in Password Management:

The aim of such use is to automatically maintain a sufficiently secure password for a web application that uses access data (username and/or password) entered by the user on its website, thereby improving the user experience and at the same time the security of authentication.

The program is configured so that it is capable of recognizing the request of the relevant web application to enter a password or to change the password. The program is further able to generate a sufficiently secure password, and store it as a value of a variable in the variables memory, and to read the value of this variable from the variables memory. Furthermore, a pre-determined level of authentication is required by the program when reading the value of this variable (the required level of authentication is pre-determined by the creator of the program).

The corresponding trigger rule ensures that the program starts when the user accesses the login page of the respective web application using the embedded browser. The program recognizes the situation when the web application requires the entry of a username and/or password, and initiates the reading of the value of the variable from the variables memory.

The system enforces user authentication (e.g. biometric authentication) using the authenticator and the browser control manager authentication server, and passes the value of the variable to the program after the user is successfully authenticated. The program uses the value to generate HTML text corresponding to the input of the username and/or password by the user and submits the HTML text to the web application.

If the program detects a situation where a password change is required by the web application, it requests the reading of the value of the variable (by the process described above), uses the value as the old password, generates a new password (with a sufficiently high entropy), stores the new password as a new value of the variable and uses it together with the old password for the password change the web application.

If the user uses multiple client devices, the subsequent process of synchronizing the variables memories on all devices ensures that the new value of the variable is transmitted to all client devices of that user.

### Use for Automating Login Procedures in Electronic Identity Systems (eID Systems):

Complicated eID systems often require users to select their identity provider and/or authentication means each time they log in. This decreases the user experience while opening up opportunities for attackers.

The program is configured so that it recognizes the request of the respective web application to select an identity provider and/or to select an authentication means. The trigger rule ensures that the program is triggered (launched) when a user accesses a web application page using a browser. The program recognizes the request to select an identity provider and/or authentication means, creates a response on behalf of the user that selects the correct item(s), and sends the response to the web application.

### Use for Protection Against Attacks on Federated Electronic Identity Systems (Federated eID Systems):

The current standard eID federation systems (using e.g. SAML or oAUTH protocols) rely on the transmission of the authentication result (assertion) using the http redirect functionality via the authenticated user's browser. However, they ignore the existence of a security weakness that allows an attacker to access the authentication result (assertion) on an unprotected channel and subsequently abuse the assertion to log in. The security of the transmission of the assertion can only be ensured if all the channels used are authenticated, which excludes the possibility of a MITM attack on each such channel. The program is therefore configured (programmed) to compare the certificates of the TLS channels used by any server involved in the eID federation. Preferably, the program is also adapted for selecting an identity provider and/or authentication means. The trigger rule ensures that the program starts when a user accesses the web application page using a browser. The program checks all the certificates of the used data channels of the given federated eID system (by comparing them with the copies of the certificates stored in the program) and thus ensures an improved user experience and limits the possibilities of social attacks.

### Use for Personalized User Interface Management:

This use is suitable when several different web applications are used in a given security domain, e.g. in a company. Different users or different groups of users have access to only certain web applications. They do not need to use or access other web applications. The goal of this use is to adapt the user interface to a given group of users so that users can easily use the web applications they need to use. The program is therefore configured to display in the user interface of the browser only those control elements (e.g. buttons with icons) of the web applications that the given user or group of users needs to use, and simultaneously to prevent the display of the control elements of other applications. For this, the program can preferably use one or more variables in the variables memory.

The program can also preferably use user authentication through the authenticator and authentication server of the browser control manager to control the transmission of programs from servers and to set trigger rules or to determine the variables to be used.

### Use for Migration of Legacy Systems:

This is useful when several different web applications are used in a given security domain, e.g. in a company; and when some web applications are migrated to applications using modern authentication using the embedded browser (e.g. as described in PV 2020-271), while other web applications in the domain use a classic authentication, e.g. with username and password. The goal of use is to unify user behavior for both types of web applications and at the same time enable future migrations of other web applications without negative impacts on the user experience.

The program is configured to display in the user interface of the browser only those control elements (e.g. buttons with icons) of web applications that the given user or group of users needs to use, and also to recognize the request of the respective web application to enter a password and/or to change the password. The program is also adapted to generate a sufficiently secure password, and store it as a value of the variable in the variables memory, and to read the value of this variable from the variables memory. These functions respond to the requirements of web applications, and allow classic authentication (eg name and password) as well as a new modern version of authentication.

When another web application is migrated, the program is modified and the modified version of the program is transmitted to the programs memory as part of the communication with the authentication server of the browser control manager. This will change the communication with the web application during authentication as well as the security procedure, while the user interface may remain the same.

### Use for Storing Confidential Information:

This use is suitable when the user needs to store, maintain and read confidential information for use in various life situations. Such confidential information can include, for example, access codes for various purposes, PINs for credit cards, confidential information for proving identity, etc.

The program is configured for storing, reading and modifying the values of variables in the variables memory. At the same time, the program can set a flag on a variable so that reading or modifying the variable requires user authentication at a pre-determined security level (e.g. strong two-factor authentication verifying the user's biometrics).

In this use, it is particularly preferred that the variables are encrypted and the encryption key needed to read the variable is stored on the authentication server. Thus, when the authentication means is stolen, the values of the variables cannot be read without authentication to the authentication server.

Confidential information can be protected, for example, by strong two-factor authentication verifying, for example, the user's biometrics.

The user can preferably read or edit confidential information on any of their devices (mobile phone, tablet, PC), and the variables corresponding to the confidential information are synchronized on all the user's devices.

### Use for Storing Verified Personal Data:

Such use is suitable for the management of personal data verified by trusted authorities. Typically, the user needs to store this verified personal data (e.g. ID card, driver's license, gun license, university diploma, certificate of completed training, verification of professional qualifications) on their devices for use in various situations.

The program is configured for saving and reading the verified personal data in/from variable memory, and it can preferably be configured also for their processing for common uses of this type of data, for example for inserting the data into e-mail communication or into forms. The program can set a flag on some variables to require user authentication in an appropriate manner at an appropriate security level. In this use, it is particularly preferred that the variables are encrypted so that the encryption key needed to read the variable is stored on an authentication server. Thus, for example, when the authentication means is stolen, the values of the variables cannot be read without authenticating to the authentication server.

Confidential information can be protected, for example, by strong two-factor authentication verifying, for example, the user's biometrics.

The user can keep confidential information on any of his devices (mobile phone, tablet, PC), and the data may be synchronized on all the user's devices. When changing devices, e.g. when obtaining a new phone, verified personal data are automatically transferred to the new device during migration of the authentication system (e.g. through a synchronization process) and can be reliably deleted from the old device.

### Use for Protection Against Malicious Code (Malware):

The program is configured to detect the manifestations of the presence of malicious code or to verify the properties of the configuration and installed software on a user device with the aim of identifying security weaknesses and/or the presence of malicious code on the device. The program can also analyse communication using the http protocol and identify access to risky servers. A program can signal security problems and/or enforce security measures according to its internal logic and the knowledge of the program creator.

The program is transmitted and updated from the browser control manager system using the authentication system to the user device, where it is executed in a controlled manner in accordance with trigger rules. The advantage of this system is that the program is able to block the user's access to an application or page that may potentially contain malicious code before the malicious code can be transferred to the user device.

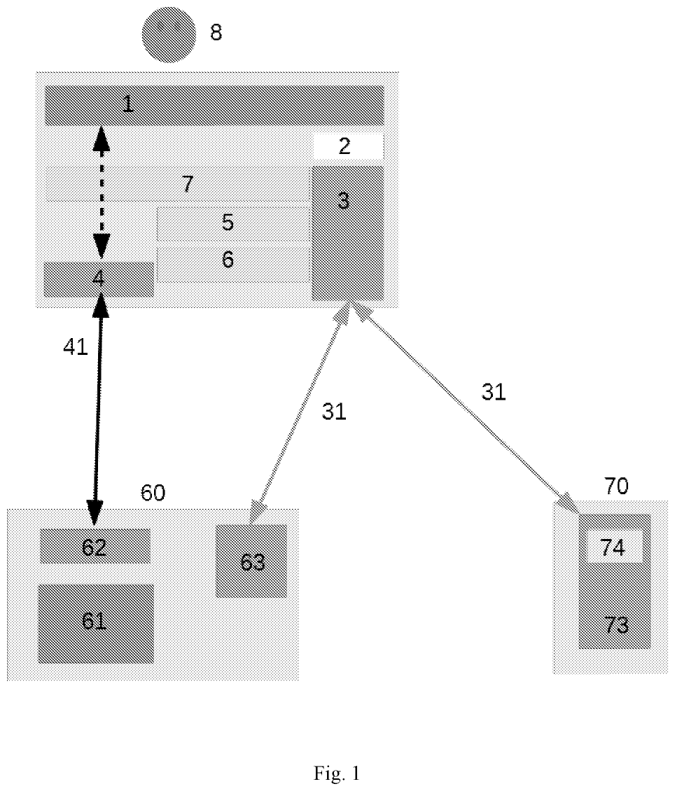

The following examples of carrying out the invention are described with reference to FIG. 1.

### Example 1—Data Channel Protection

The aim of the program is to exclude the possibility of the presence of an attacker presence in the data channel 41 between the client part of the system and the target application.

The program is configured to compare the certificate of the TLS channel 41 with the genuine certificate related to the respective web server of the target application 61 or proxy server 62 of a service provider 60. The target application or the service provider is specified by the creator of the program.

The browser control manager 70 uploads the program and the corresponding trigger rule to a synchronization queue 74 of an authentication server 73 managed by the browser control manager 70. When the user 8 starts their device, the authenticator 3, using the authentication server 73 of the browser control manager and the authentication communication 31, takes over the program and the trigger rule from the synchronization queue 74 of the authentication server 73 managed by the browser control manager 70, and securely transmits the program to the programs memory 5 and the trigger rule to a control module 7.

The trigger rule ensures that the program is launched whenever the user 8 communicates with the web server of the target application 61. When the user 8 accesses the web server of the target application 61 of the service provider 60 using the browser 1, the program is launched. It compares the server certificate of the TLS channel 41 used by the browser with the reference certificate stored in the program. If there is a match, the program allows the user to access the web server of the target application 61 because it is explicitly verified that the data channel 41 is properly secured and not attacked by an attacker.

In the event of a mismatch, the program displays an appropriate error message using the browser 1 and prevents the use of the attacked data channel.

### Example 2—Password Management

The aim of the program is to automatically maintain a secure password for a target web application 61. This increases the user experience and simultaneously also the security of authentication.

The program is configured to recognize the request of the target web application 61 to enter the password and/or to change the password. The program is also configured to be able to generate a password with sufficient entropy, save it as a value of a variable in the memory 6 of variables, and read from this variable.

The program creator determines how strong user authentication should be used when reading the value of a given variable.

The browser control manager 70 uploads the program and the trigger rule to the synchronization queue 74 of the authentication server 73 managed by the browser control manager 70.

When the user 8 starts their device, the authenticator 3, using the authentication server 73 of the browser control manager 70 and authentication communication 31, takes over the program and the trigger rule from the synchronization queue 74 of the authentication server 73 managed by the browser control manager 70, and securely uploads the program to the programs memory 5 and the trigger rule to the control module Z.

The program is launched by the control module 7 based on the trigger rule when the user accesses the login page of the target application 61 using the embedded browser 1.

The program recognizes when a password is required, and the program then requests reading the value of the variable, the request is sent to the authenticator 3.

The authenticator 3 together with the authentication server, e.g. the authentication server 63 managed by the service provider 60 or the authentication server 73 managed by the browser control manager 70, using the authentication communication 31, forces the appropriate authentication of the user, e.g. biometrics verification.

After a successful authentication of the user, the authenticator 3 reads the encrypted variable value from the variables memory 6, decrypts it with the help of the authentication server and using the authentication communication 31 and passes the decrypted value to the program. The program uses the value to generate an HTML text corresponding to the input of the password by the user and submits the HTML text to the target application 61.

When the program recognizes a situation where a password change is required, it analogously requests the reading of the value of the variable, the request is sent to the authenticator 3. The decrypted value of the variable is used as the old password. The program generates a new password with a high entropy, preferably with the help of the authenticator 3. The new password is saved as a new value of the variable in the variables memory 6, preferably the authenticator 3 cooperates in the saving procedure (saving and encrypting).

The authentication system then ensures secure synchronization of the new value of the variable on all devices (replicas) of the user. The authenticator 3 and the authentication server, using the authentication communication 31 upload the new encrypted value in the relevant synchronization queue, e.g. in the synchronization queue 74 of the authentication server 73 managed by the browser control manager 70. When the user & uses another of his devices with the installed client part of the system, the authenticator 3 of this other device, using the authentication server, e.g. the authentication server 73 of the browser control manager 70, and the authentication communication 31, transmits the new encrypted variable value from the synchronization queue 74 and stores it securely in the variables memory 6 of the device.

### Example 3—Migration of Legacy Systems

The use of the invention for the migration of legacy systems is useful when several different web applications are used in a given security domain, e.g. in a company; while some web applications are migrated to applications using integrated authentication using the embedded browser (described in PV 2020-271), and while other web applications in the domain use a classic username and password authentication (legacy applications). The aim is to unify the user behaviour for both types of web applications while enabling future migrations of legacy web applications without negative impacts on the user experience.

A first program is configured to display in the browser interface, using the embedded browser 1, only the control elements (e.g. buttons with icons) of the web applications that the given user or group of users needs to use.

Simultaneously, the first program provides password management as described in example 2 for each legacy web application that uses classic login using a username and password.

The browser control manager 70 uploads the first program and the trigger rule to the synchronization queue 74 of the authentication server 73 managed by the browser control manager 70.

When the user 8 starts their device, the authenticator 3, using the authentication server 73 of the browser control manager 70 and the authentication communication 31, transmits from the synchronization queue 74 of the authentication server 73 managed by the browser control manager 70 the first program and the trigger rule, and securely uploads the first program to the programs memory 5 and the trigger rule into the control module 7.

The program is started by the control module 7 based on the trigger rule when the user accesses with the embedded browser 1 the login page of a target web application 61.

In the case of access to a legacy application, the program recognizes the situation where a password is required, and the program then requests to read the value of the variable, the request is sent to the authenticator 3.

The authenticator 3 together with an authentication server, e.g. the authentication server 63 managed by the service provider 60 or the authentication server 73 managed by the browser control manager 70, using the authentication communication 31, forces the authentication of the user, e.g. by verifying biometrics.

After a successful authentication of the user, the authenticator 3 reads the encrypted value of the variable from the variables memory 6, decrypts the encrypted value with the help of the authentication server and using the authentication communication 31 and passes the decrypted value to the program. The program uses the value to create an HTML text corresponding to the password as entered by the user, the HTML text is submitted by the legacy application to the target application 61.

In the next step, when migrating a legacy web application, the first program is updated, the updated version is called herein a second program. The behaviour of the second program is different for the migrated web application. The behaviour of the second program for other applications remains the same as the behaviour of the first program. For the migrated web application, password management is omitted and replaced by strong authentication.

The browser control manager 70 uploads the second program and the trigger rule to the synchronization queue 74 of the authentication server 73 managed by the browser control manager 70. When the user 8 starts their device, the authenticator 3, using the authentication server 73 of the browser control manager 70 and the authentication communication 31, transmits the second program from the synchronization queue 74 and securely uploads the second program to the programs memory 5, where the second program replaces the first program, and the trigger rule is transmitted into the control module 7.

The second program is started by the control module 7 based on the trigger rule when the user accesses with the embedded browser 1 the login page of the target application 61.

User behaviour is preserved while the web application has been migrated to a higher level of security.

### Example 4—Storing Verified Personal Data

The use of the invention for storing verified personal data is suitable for managing verified personal data assigned to the user by the authorities. The user cannot freely select of change the data. The user needs to store and maintain the verified personal information (e.g. driver's license, university diploma, certificate of completed training, verification of professional qualifications) for use in various situations during their life.

The program is configured to record, save, read, or modify the values of variables in the variables memory 6, using the variables to store the electronic form of the personal data. Appropriate security level is applied to the variables.

The program is configured to enable displaying content using the embedded browser 1 in browser user interface, including the possibility of further use, for example, for inserting the personal data into e-mail communication or into web forms.

The browser control manager 70 uploads the program and the trigger rule to the synchronization queue 74 of the authentication server 73 managed by the browser control manager 70.

When the user 8 starts their device, the authenticator 3, using the authentication server 73 of the browser control manager 70 and the authentication communication 31, transmits the program and the trigger rule from the synchronization queue 74, and securely uploads the program to the programs memory 5 and the trigger rule to the control module 7.

The program is started by the control module 7 based on the trigger rule when the user accesses with the embedded browser 1 the webpage of the target application 61.

Using the button displayed by the program, the user 8 can agree to insert the value of the relevant variable from the variables memory 6 into an item of a web form of the target application 61.

Since the value of the variable in the variable memory 6 is synchronized to other devices of the same user 8 using the authenticator 3, the authentication communication 31, the authentication server 73 of the browser control manager 70 or an authentication server 63 managed by a service provider, the value of the variable is the same on all devices of the user 8, and therefore, it contains the same personal data. When the user 8 uses another device, the authenticator 3, using the authentication server 73 of the browser control manager 70 and the authentication communication 31, transmits from the synchronization queue 74 the program and the trigger rule and securely uploads the program into the programs memory 5 and the trigger rule into the control module 7.

Thus, on such another device the same program is controlled by the same trigger rule(s) and uses the same variables with the same values as on the first device.

1. A system for controlling access of a user to service providers and/or to target applications, said system comprising:
a client part, and
a server part,
wherein the client part contains an authenticator (3), an embedded browser (1) and a data channel module (4),
wherein the authenticator (3) is configured to authenticate the user (8); and
wherein the authenticator (3) is also configured to communicate with the user via a graphical user interface of the embedded browser (1) using graphical and control primitives (2) of the authenticator and/or using a stand-alone graphical user interface of the authenticator;
wherein the data channel module (4) is configured to communicate with service provider (60) servers via http/https protocol, to communicate with the embedded browser (1) and to communicate with the authenticator (3);
wherein the client part further contains a program memory (5), a variables memory (6), and a control module (7) configured to control the execution of programs stored in the program memory (5); and
wherein the server part contains at least one authentication server (73) of a browser control manager (70).

2. The system according to claim 1, wherein the client part is provided on one or more devices of the user.

3. The system according to claim 1, wherein the control module (7) is configured to monitor all communication of the embedded browser (1) with the servers of the service providers (60).

4. The system according to claim 1, wherein the authenticator (3) is configured to authenticate the data channel (41), and wherein the authenticator (3) is configured to bind the user authentication to the authenticated channel (41).

5. The system according to claim 1, wherein the control module (7) is configured to pass over the program code to the embedded browser (1) for execution once a trigger rule for the launch of the program is fulfilled.

6. The system according to claim 1, wherein the program is a computer program programmed to select from a pre-determined server or for a pre-determined web interface or for a pre-determined service provider webpage.

7. The system according to claim 1, wherein the program is configured for verification of a certificate of the webpage by comparing the certificate with a copy of the certificate contained in the program or with information derived from the certificate contained in the program; and/or the program is configured for authentication communication with the service provider webpage; and/or the program is configured for simplification of user interaction.

8. The system according to claim 1, wherein the variables memory (6) is configured for storing encrypted values of variables, wherein information needed for the decryption of the values must be obtained from a server to which the user or the device must authenticate.

9. The system according to claim 1, wherein the system is configured to synchronize the program memory (5), the variables memory (6) and the trigger rules in the control module (7) between a plurality of devices of the same user.

10. A computer-implemented method of controlling the access of a user to a service provider and/or to a target application, in particular to a target web application, said method using the system and comprising the steps of:
a) transmitting from an authentication server (73) of a browser control manager (70) to a user device at least one program and trigger rule(s) for its/their launch, whereby the at least one program is stored in a program memory (5) and the trigger rule(s) is/are stored in a control module (7);
b) receiving a user (8) request to use a service of a service provider (60) and/or to access a service provider (60) data and/or to access a target application of a service provider (60), wherein the request is received via the embedded browser (1);
c) launching a program according to the trigger rule(s) which are fulfilled by the user request, said launching step is performed by the control module (7);
d) transmitting the user request, wherein the request is unauthenticated and unencrypted, to a data channel module (4);
e) creating a data channel (41) with http/https communication between the data channel module (4) and the service provider (60), initiating authentication by the data channel module (4), and transmitting authentication data from the data channel module (4) to an authenticator (3);
wherein the executed program may provide data for authentication in the target application and/or to the service provider (60) authentication server; wherein if the program specifies the need for user authentication to read the value of the variable, this authentication is performed by the authenticator (3) and the authentication server (73) of the browser control manager (70) or an authentication server (63) of the service provider (60) before passing the value of the variable to the program; and/or if it is required to verify the certificate of the service provider (60) or other communication partner, the program compares the certificate received from the service provider (60) or other communication partner with a copy of the certificate contained in the program or stored in the variable corresponding to the program;
f) transmitting the user request, via the data channel module (4) and via the data channel (41) to the service provider (60); and
g) providing the service of the service provider (60) and/or access to the data of the service provider (60) and/or access to the target application of the service provider (60) to the user.

11. The method according to claim 10, wherein the step a) is performed so that an authenticator (3) mediates the communication with the browser control manager authentication server (73) over a secure data channel (31).

12. The method according to claim 10, wherein the at least one program, the trigger rules and/or the variables are synchronized via synchronization queues on authentication servers (63, 73).

13. The method of claim 10, further comprising the step of:
authenticating the data channel (41) created in step e) and authenticating the user through the authentication communication of the authenticator (3) with the authentication server of the service provider (60).

14. The method of claim 13, wherein the data channel (41) is preferably bound to the user authentication.

15. The method of claim 11, wherein step a) requires authentication of the user or their device or the client part of the system to the browser control manager authentication server (73).
